(19) United States
(12) Patent Application Publication
(10) Pub. No.: US 2015/0358081 A1
(43) Pub. Date: Dec. 10, 2015

(54) OPTICAL FIBER COMMUNICATION METHOD AND SYSTEM

(71) Applicant: I SHOU UNIVERSITY, Kaohsiung City (TW)

(72) Inventors: Nai-Hsiang SUN, Kaohsiung City (TW); Chia-Ming HU, Kaohsiung City (TW); Jung-Sheng CHIANG, Kaohsiung City (TW); Wen-Fung LIU, Kaohsiung City (TW); Gary A. EVANS, Kaohsiung City (TW); Jerome K. BUTLER, Kaohsiung City (TW)

(21) Appl. No.: 14/297,556

(22) Filed: Jun. 5, 2014

(51) Int. Cl. H04B 10/25

(52) U.S. Cl. CPC H04B 10/2504

(57) ABSTRACT

An optical fiber communication method includes the steps of: providing an optical fiber that includes a core, and a second-order Bragg grating structure formed on the core; and emitting a data-carrying optical signal to an outer peripheral surface of the optical fiber that corresponds to the second-order Bragg grating structure in a radial direction of the optical fiber, so that the data-carrying optical signal is coupled into the core of the optical fiber via the second-order Bragg grating structure for transmission therein.

### BACKGROUND OF THE INVENTION

1. Field of the Invention

The invention relates to optical fiber communication, and more particularly to a method and system of optical fiber communication using a second-order Bragg grating structure.

2. Description of the Related Art

Referring to FIGS. 1(a) and 1(b), a conventional optical fiber communication system includes an optical fiber 11 having two ends respectively coupled to a light emitting device 12 and a receiver device 13. The light emitting device 12 emits an optical signal into the optical fiber 11, and the optical signal is received by the receiver device 13. Using the conventional optical fiber communication system to transmit optical signals is advantageous in terms of high data transmission rate, low power consumption, not affected by electromagnetic interference, small size and low cost.

However, when an additional optical signal is to be coupled into the optical fiber 11 at a middle portion of the optical fiber 11, a conventional method is to process the middle portion of the optical fiber 11, so as to connect an optical coupler 14 with a lens or a medium (i.e., a location at which the additional optical signal is coupled into the optical fiber 11) for coupling the additional optical signal from another light emitting device 15 into the optical fiber 11 via the optical coupler 14, resulting in more inconvenience.

### SUMMARY OF THE INVENTION

Therefore, an object of the present invention is to provide an optical fiber communication method adapted for optical coupling at a middle portion of the optical fiber without, an additional medium, lens, or optical coupler.

According to one aspect of the present invention, an optical fiber communication method comprises the steps of:
providing an optical fiber that includes a core, and a second-order Bragg grating structure formed on the core; and
emitting, using a light emitting device, a data-carrying optical signal to an outer peripheral surface of the optical fiber that corresponds to the second-order Bragg grating structure in a radial direction of the optical fiber, so that the data-carrying optical signal is coupled into the core of the optical fiber via the second-order Bragg grating structure for transmission therein.

Another object of the present invention is to provide an optical fiber communication system adapted for optical coupling at a middle portion of the optical fiber without an additional medium, lens, or optical coupler.

According to another aspect of the present invention, an optical fiber communication system comprises:
an optical fiber including a core, and a second-order Bragg grating structure formed on the core; and
a light emitting device configured to emit a data-carrying optical signal to an outer peripheral surface of the optical fiber that corresponds to the second-order Bragg grating structure in a radial direction of the optical fiber, so that the data-carrying optical signal is coupled into the core of the optical fiber via the second-order Bragg grating structure for transmission therein.

### BRIEF DESCRIPTION OF THE DRAWINGS

Other features and advantages of the present invention will become apparent in the following detailed description of the preferred embodiments with reference to the accompanying drawings, of which:

FIGS. 1(a) and 1(b) are schematic diagrams illustrating a conventional optical fiber communication method and system;

FIG. 2 is a schematic diagram illustrating a preferred embodiment of the optical fiber communication system according to the present invention;

FIG. 3 is a flow chart illustrating a preferred embodiment of the optical fiber communication method according to the present invention;

FIG. 4 is a plot showing power of an optical signal received by an optical power meter coupled to an end of an optical fiber in the system of the preferred embodiment; and

FIG. 5 is a plot showing power of an optical signal received by an optical power meter coupled to the other end of the optical fiber in the system of the preferred embodiment.

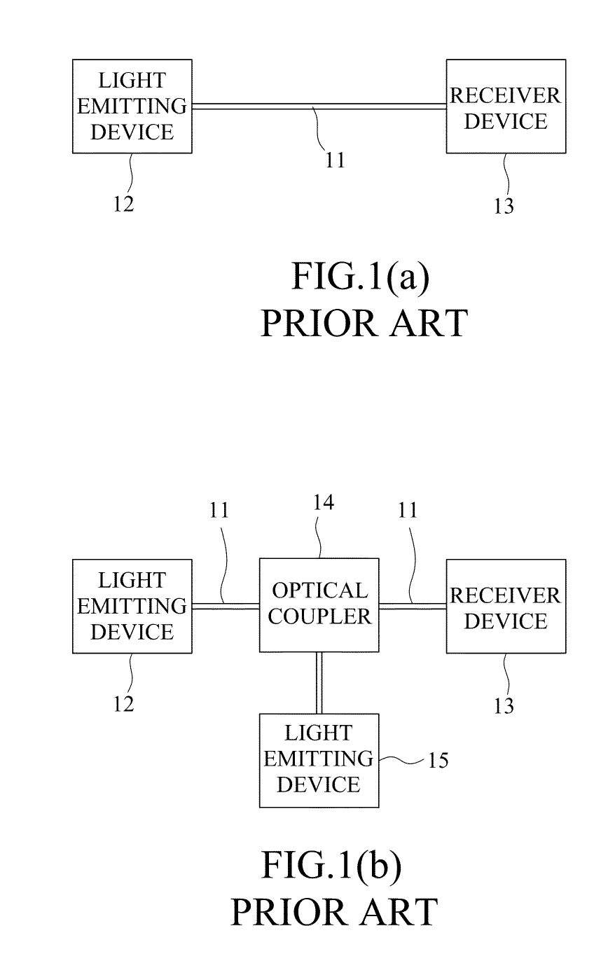

### DETAILED DESCRIPTION OF THE PREFERRED EMBODIMENTS

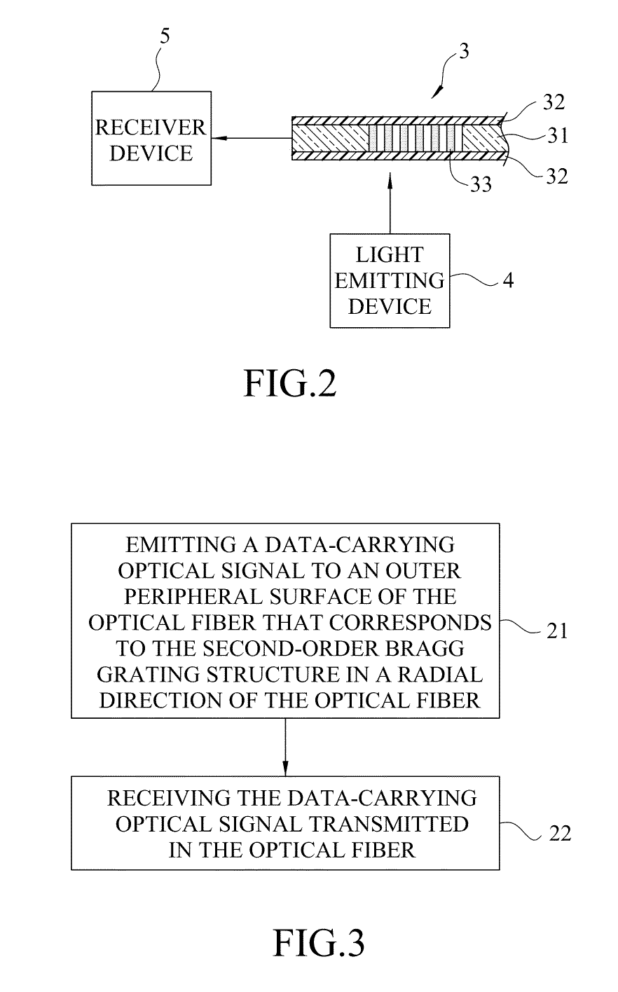

Referring to FIG. 2, the preferred embodiment of the optical fiber communication system according to this invention is shown to include an optical fiber 3, a light emitting device 4, and a receiver device 5 coupled to the optical fiber 3, and is adapted for communication using optical signals.

The optical fiber 3 includes a core 31, a cladding 32 that covers the core 31, and a second-order Bragg grating structure 33 formed on the core 31. The second-order Bragg grating structure 33 has a periodically varying refractive index that varies according to a grating period thereof and that defines an effective refractive index.

The receiver device 5 is coupled to an end of the optical fiber 3 that is distal from the second-order Bragg grating structure 33.

The light emitting device 4 emits a data-carrying optical signal to an outer peripheral surface of the optical fiber 3 that corresponds to the second-order Bragg grating structure 33.

Further referring to FIG. 3, the optical fiber communication system according to the present invention is provided to implement an optical fiber communication method for communication using optical signals. The method includes an optical coupling step 21 and a receiving step 22.

In the optical coupling step 21, the light emitting device 4 emits the data-carrying optical signal to the outer peripheral surface of the optical fiber 3 that corresponds to the second-order Bragg grating structure 33 in a radial direction of the optical fiber 3 (i.e., a direction perpendicular to an outer surface of the optical fiber 3), so that the data-carrying optical signal is coupled into the core 31 of the optical fiber 3 via the cladding 32 and the second-order Bragg grating structure 33 for transmission in the core 31. It should foe noted that, in some embodiments, the cladding 32 may foe peeled off at a portion corresponding to the second-order Bragg grating structure 33 for better optical coupling efficiency. In the receiving step 22, the receiver device 5 receives the data-carrying optical signal transmitted in the optical fiber 3, and the optical communication between the light emitting device 4 and the receiver device 5 is thus completed.

Particularly, the data-carrying optical signal that is coupled into the core 31 of the optical fiber 3 has a peak power at a particular wavelength λ expressed by λ=n_{eff}·Λ, where n_{eff} represents the effective refractive index of the second-order Bragg grating structure 33, and Λ represents the grating period of the second-order Bragg grating structure 33. In other words, the grating period of the second-order Bragg grating structure 33 may be designed according to the desired wavelength of the data-carrying optical signal and the effective refractive index.

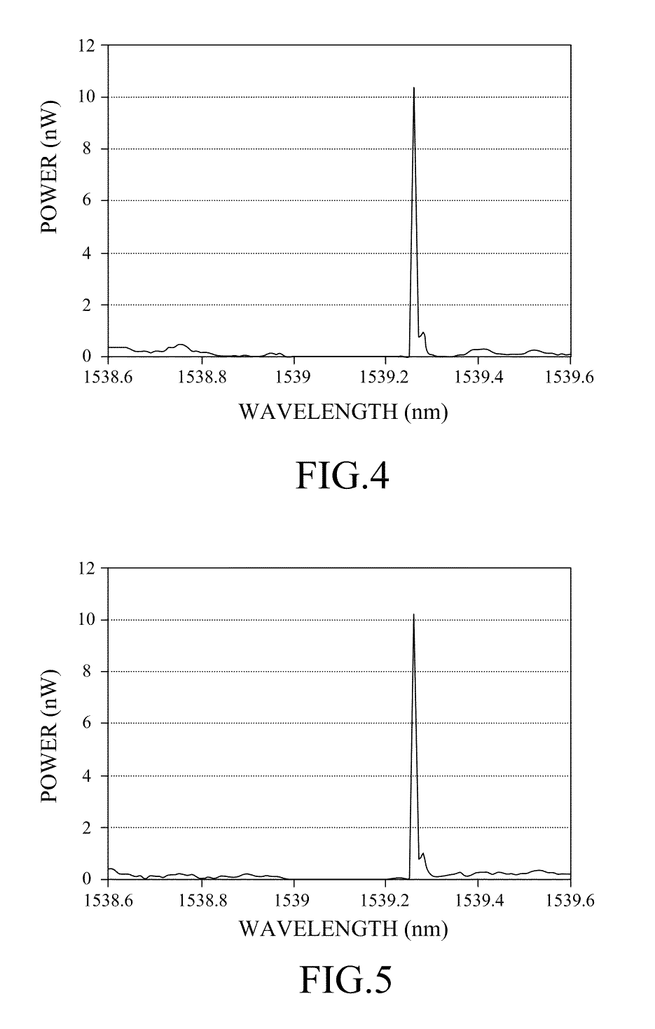

Referring to FIGS. 4 and 5, in order to verify the effect of the preferred embodiment of the optical fiber communication method according to the present invention, a photosensitive optical fiber is used as the optical fiber 3, and the second-order Bragg grating structure 33 is formed on the core 31 of the optical fiber 3 by using a phase mask for UV (ultraviolet) exposure for a duration of about 3 minutes. It should be noted that formation of the second-order Bragg fiber grating in the present invention should not be limited to UV exposure, and other methods to form the second-order Bragg fiber grating may be suitable for use in the present invention. Two optical power meters are respectively coupled to two ends of the optical fiber 3 for receiving and measuring power of an optical signal transmitted in the core 31. A tunable laser source and an erbium-doped fiber amplifier are used as the light emitting device 4. In the experiment, the tunable laser source emits an optical signal at a power of 3.98 mW, the erbium-doped fiber amplifier amplifies the power of the optical signal to 12.302 mW, and the optical signal is emitted to the outer peripheral surface of the optical fiber 3 that corresponds to the second-order Bragg grating structure 33 in the radial direction of the optical fiber 3.

The optical power meters respectively received peak power values of 10.715 nW and 10.233 nW at a wavelength of 1539.26 nm that is substantially equal to a product of the grating period and the effective refractive index of the second-order Bragg grating structure 33 (i.e., λ=n_{eff}·Λ). The plots in FIGS. 4 and 5 prove that the optical fiber communication method of this invention, which uses the light emitting device 4 to emit the optical signal to the outer peripheral surface of the optical fiber 3 that corresponds to the second-order Bragg grating structure 33 in the radial direction of the optical fiber 3, is capable of coupling light into the optical fiber 3 without an additional medium, lens or optical coupler.

To sum up, the optical fiber communication method and system of the present invention couple the data-carrying optical signal emitted by the light emitting device 4 into the core 31 of the optical fiber 3 via the second-order Bragg grating structure 33 formed on the core 31 for receipt by the receiver device 5. An additional lens, medium or optical coupler is not required in this invention for optical coupling, to thereby enhance convenience during use.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An optical fiber communication method comprising;
providing an optical fiber that includes a core, and a second-order Bragg grating structure formed on the core; and
emitting, using a light emitting device, a data-carrying optical signal to an outer peripheral surface of the optical fiber that corresponds to the second-order Bragg grating structure in a radial direction of the optical fiber, so that the data-carrying optical signal is coupled into the core of the optical fiber via the second-order Bragg grating structure for transmission therein.

2. The optical fiber communication method as claimed in claim 1, further comprising the step of receiving, using a receiver device coupled to an end of the optical fiber that is distal from the second-order Bragg grating structure, the data-carrying optical signal transmitted in the optical fiber.

3. The optical fiber communication method as claimed in claim 1, wherein the data-carrying optical signal that is coupled into the core of the optical fiber has a peak power at a wavelength substantially equal to a product, of a grating period of the second-order Bragg grating structure and an effective refractive index defined by a periodically varying refractive index of the second-order Bragg grating structure.

4. The optical fiber communication method as claimed in claim 1, wherein the second-order Bragg structure has a grating period substantially equal to a quotient of a wavelength of the data-carrying optical signal and an effective refractive index defined by a periodically varying refractive index of the second-order Bragg grating structure.

5. An optical fiber communication system comprising:
an optical fiber including a core, and a second-order Bragg grating structure formed on said core; and
a light emitting device configured to emit a data-carrying optical signal to an outer peripheral surface of said optical fiber that corresponds to said second-order Bragg grating structure in a radial direction of said optical fiber, so that the data-carrying optical signal is coupled into said core of said optical fiber via said second-order Bragg grating structure for transmission therein.

6. The optical fiber communication system as claimed in claim 5, further comprising a receiver device coupled to an end of said optical fiber that is distal from said second-order Bragg grating structure, and configured to receive the data-carrying optical signal transmitted in said optical fiber.

7. The optical fiber communication system as claimed in claim 5, wherein the data-carrying optical signal that is coupled into said core of said optical fiber has a peak power at a wavelength substantially equal to a product of a grating period of said second-order Bragg grating structure and an effective refractive index defined by a periodically varying refractive index of said second-order Bragg grating structure.

8. The optical fiber communication system as claimed in claim 5, wherein said second-order Bragg structure has a grating period substantially equal to a quotient of a wavelength of the data-carrying optical signal and an effective refractive index defined by a periodically varying refractive index of said second-order Bragg grating structure.
